(19) United States
(12) Patent Application Publication
(10) Pub. No.: US 2021/0333923 A1
(43) Pub. Date: Oct. 28, 2021

(54) INFORMATION PROCESSING APPARATUS AND INPUT CONTROL METHOD

(71) Applicant: Lenovo (Singapore) Pte. Ltd., Singapore (SG)

(72) Inventors: Masaki Matsubara, Kanagawa (JP); Norihito Ozeki, Kanagawa (JP); Thixuanmai Tran, Kanagawa (JP); Markus Takashi Heberlein, Kanagawa (JP)

(73) Assignee: Lenovo (Singapore) Pte. Ltd., Singapore (SG)

(21) Appl. No.: 16/906,565

(22) Filed: Jun. 19, 2020

Related U.S. Application Data
(60) Provisional application No. 63/016,701, filed on Apr. 28, 2020.

(51) Int. Cl. G06F 3/041

(52) U.S. Cl. CPC G06F 3/0418; G06F 3/0414

(57) ABSTRACT

An information processing apparatus includes: a pressure detection unit that detects a contact pressure on an operation surface of a touchpad; an area detection unit that detects a contact area on the operation surface of the touchpad; a threshold setting unit that sets a pressure threshold that differs depending on the contact area on the operation surface of the touchpad; and a determination unit that determines an input operation as a predetermined input operation, in a case where the contact pressure on the operation surface of the touchpad is greater than or equal to the pressure threshold.

### FIELD OF THE INVENTION

The present invention relates to an information processing apparatus and an input control method.

### BACKGROUND OF THE INVENTION

Information processing apparatuses using force touch (pressure-sensitive touch), i.e. a technology of detecting the strength (pressure) with which a touch panel or a touchpad is touched and reflecting the detected strength (pressure) in the operation, have been proposed in recent years.

A capacitive touchpad is capable of detecting the position at which a finger or the like touches the touchpad and the position at which the finger or the like separates from the touchpad. A touch panel or a touchpad using force touch combines this with a pressure sensor, to be capable of detecting the strength of the pressure with which the surface is pressed. This makes it possible to change the operation between when the surface is lightly touched and when the surface is firmly pressed. Hence, various instructions can be input depending on the pressure strength of the touch.

When using a keyboard or a trackpoint on such a touchpad that uses the force touch technology, there is a possibility that a part of the hand, such as the side of the hand, unintentionally touches the touchpad and the touch is treated as input. It is desirable that such an input operation not intended by the user is determined as an input error and is not treated as input.

### SUMMARY OF THE INVENTION

One or more embodiments of the present invention provide an information processing apparatus that can prevent an input error caused by an input operation not intended by a user on a touchpad capable of detecting contact pressure, and an input control method.

A first aspect of the present invention is an information processing apparatus including: a pressure detection unit configured to detect a contact pressure on an operation surface of a touchpad; an area detection unit configured to detect a contact area on the operation surface of the touchpad; a threshold setting unit configured to set a pressure threshold that differs depending on the contact area; and a determination unit configured to determine an input operation as a predetermined input operation, in the case where the contact pressure on the operation surface of the touchpad is greater than or equal to the pressure threshold.

A second aspect of the present invention is an information processing apparatus including: a touchpad; a trackpoint; a threshold setting unit configured to set a pressure threshold that differs depending on whether the trackpoint is in use; and a determination unit configured to determine an input operation as a predetermined input operation, in the case where a contact pressure on an operation surface of the touchpad is greater than or equal to the pressure threshold.

A third aspect of the present invention is an input control method for an information processing apparatus including a touchpad, the input control method including: a step of detecting a contact pressure on an operation surface of the touchpad; a step of detecting a contact area on the operation surface of the touchpad; a step of setting a pressure threshold that differs depending on the contact area; and a step of determining an input operation as a predetermined input operation, in the case where the contact pressure on the operation surface of the touchpad is greater than or equal to the pressure threshold.

A fourth aspect of the present invention is an input control method for an information processing apparatus including a touchpad and a trackpoint, the input control method including: a step of setting a pressure threshold that differs depending on whether the trackpoint is in use; and a step of determining an input operation as a predetermined input operation, in the case where a contact pressure on an operation surface of the touchpad is greater than or equal to the pressure threshold.

A fifth aspect of the present invention is an input control for use in an information processing apparatus including a touchpad, the input control causing a computer to execute: a process of detecting a contact pressure on an operation surface of the touchpad; a process of detecting a contact area on the operation surface of the touchpad; a process of setting a pressure threshold that differs depending on the contact area; and a process of determining an input operation as a predetermined input operation, in the case where the contact pressure on the operation surface of the touchpad is greater than or equal to the pressure threshold.

A sixth aspect of the present invention is an input control for use in an information processing apparatus including a touchpad and a trackpoint, the input control causing a computer to execute: a process of setting a pressure threshold that differs depending on whether the trackpoint is in use; and a process of determining an input operation as a predetermined input operation, in the case where a contact pressure on an operation surface of the touchpad is greater than or equal to the pressure threshold.

The above-described aspects of the present invention have an advantageous effect of preventing an input error caused by an input operation not intended by a user on a touchpad capable of detecting contact pressure.

### BRIEF DESCRIPTION OF THE DRAWINGS

FIG. 1 is a schematic external view of a laptop PC according to a first embodiment of the present invention.

FIG. 2 is a diagram schematically illustrating a hardware structure of the laptop PC according to the first embodiment of the present invention.

FIG. 3 is a functional block diagram schematically illustrating a functional structure relating to an input control function of the laptop PC according to the first embodiment of the present invention.

FIG. 4 is a diagram illustrating an example of pressure threshold information used in the laptop PC according to the first embodiment of the present invention.

FIG. 5 is a flowchart illustrating an example of a procedure of an input control method according to the first embodiment of the present invention.

FIG. 6 is an explanatory diagram for describing an operation error that occurs in the case of using a keyboard.

FIG. 7 is a diagram illustrating a division example in the case of virtually dividing an operation surface of a touchpad in the laptop PC according to the first embodiment of the present invention.

FIG. 8 is a diagram illustrating an example of pressure threshold information used in the case of virtually dividing the touchpad as illustrated in FIG. 7.

FIG. 9 is a functional block diagram schematically illustrating a functional structure relating to an input control function of a laptop PC according to a second embodiment of the present invention.

FIG. 10 is a diagram illustrating an example of pressure threshold information used in the laptop PC according to the second embodiment of the present invention.

FIG. 11 is a flowchart illustrating an example of a procedure of an input control method according to the second embodiment of the present invention.

FIG. 12 is an explanatory diagram for describing an operation error that occurs in the case of using a trackpoint.

FIG. 13 is a diagram illustrating a division example in the case of virtually dividing an operation surface of a touchpad in the laptop PC according to the second embodiment of the present invention.

FIG. 14 is a diagram illustrating an example of pressure threshold information used in the case of virtually dividing the touchpad as illustrated in FIG. 13.

### DETAILED DESCRIPTION OF THE INVENTION

### First Embodiment

An information processing apparatus and an input control method according to a first embodiment of the present invention will be described below, with reference to drawings.

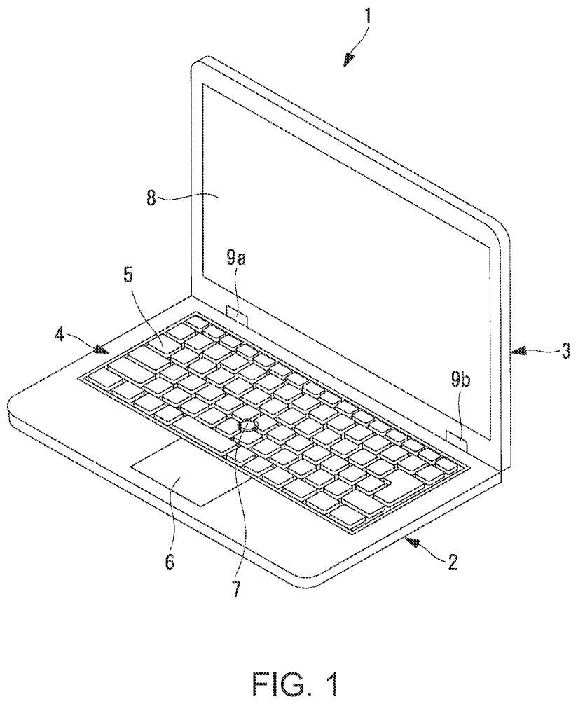

FIG. 1 is a schematic external view of a laptop PC 1 according to the first embodiment of the present invention. As illustrated in FIG. 1, the laptop PC 1 includes a main body-side chassis 2 and a display-side chassis 3 each of which is approximately a rectangular parallelepiped.

The main body-side chassis 2 is provided with an input device 4. The input device 4 is a user interface for a user to perform input operations. In FIG. 1, a keyboard 5 composed of various keys for inputting characters, commands, etc. is illustrated as an example of the input device 4. The input device 4 also includes pointing devices such as a touchpad 6 and a trackpoint 7.

The touchpad 6 is located, for example, in front of (i.e. on the user side of) a space key located approximately at the center of the keyboard 5. The touchpad 6 is a touchpad having a pressure detection function. For example, a pressure sensor is provided below the operation surface of the touchpad 6, to detect contact pressure on the contact surface. A specific structure for detecting pressure is not limited to a pressure sensor, and contact pressure by an indicator such as a finger on the contact surface may be detected by other sensors. The touchpad 6 may further include a capacitive, resistive, or electromagnetic induction type touch sensor, in addition to a pressure sensor.

The display-side chassis 3 is provided with a display 8 for displaying images.

For example, the main body-side chassis 2 and the display-side chassis 3 are connected by a pair of left and right connecting portions 9a and 9b at their respective edges. The connecting portions 9a and 9b are hinges, and support the main body-side chassis 2 and the display-side chassis 3 in an openable and closable state.

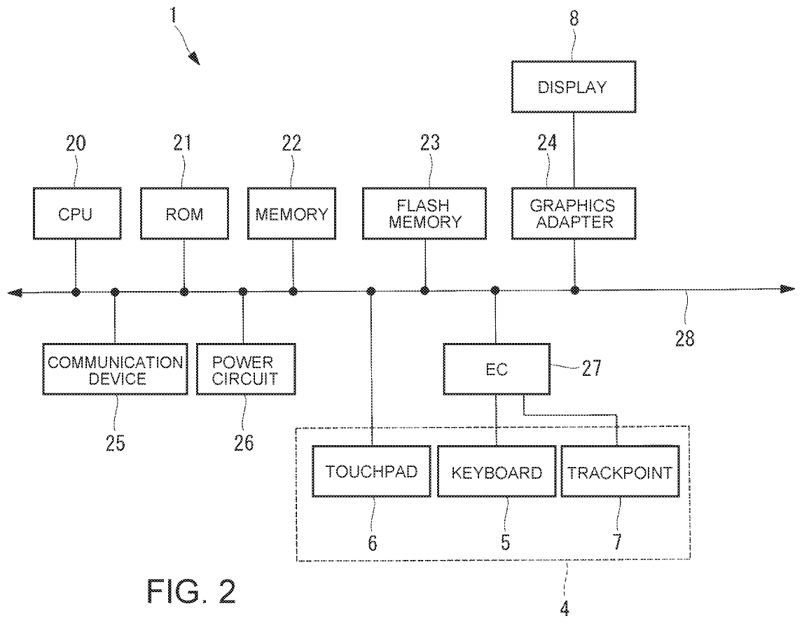

FIG. 2 is a diagram schematically illustrating a hardware structure of the laptop PC 1 according to this embodiment. The laptop PC 1 includes a central processing unit (CPU) 20, a read only memory (ROM) 21, a memory 22, a flash memory 23, a graphics adapter 24, the display 8, a communication device 25, a power circuit 26, and an embedded controller (hereafter referred to as “EC”) 27. These units are connected via a bus 28.

The CPU 20 controls the whole laptop PC 1 according to an operating system (OS) stored in the flash memory 23 connected via the bus 28, and performs processes based on information from the input device 4 according to various programs stored in the flash memory 23.

The ROM 21 stores BIOS (Basic Input/Output System), various data, and the like.

The memory 22 includes a cache memory and/or a random access memory (RAM). The memory 22 is a rewritable memory used as a working area for reading an execution program of the CPU 20 and writing data processed according to the execution program.

The flash memory 23 stores a multi-window OS for controlling the whole laptop PC 1, various drivers for operating peripheral equipment by hardware, utility programs, various application programs, etc. The laptop PC 1 may include other storage means such as a hard disk drive (HDD), instead of the flash memory 23.

The display 8 is, for example, a liquid crystal display (LCD), and displays a video signal from the graphics adapter 24 as an image according to control by the CPU 20.

The graphics adapter 24 converts display information into a video signal and outputs the video signal to the display 8, according to control by the CPU 20.

The communication device 25 communicates with other devices.

The power circuit 26 includes an AC adapter, a battery, a charger for charging the battery, a DC/DC converter, and the like, and supplies power to each structure according to control by the CPU 20.

The EC 27 is connected to the keyboard 5 and the trackpoint 7. Operation information by the user on the keyboard 5 or the trackpoint 7 is output to the CPU 20 via the embedded controller 27.

The touchpad 6 is directly connected to the bus 28, without the embedded controller 27 being interposed therebetween.

The connections illustrated in FIG. 2 are an example, and the present invention is not limited to such. For example, the touchpad 6 may be connected to the bus 28 via the EC 27. A structure in which the keyboard 5 and/or the trackpoint 7 is directly connected to the bus 28 without the EC 27 being interposed therebetween is also applicable. A structure in which the touchpad 6 functions as a host device for the trackpoint 7 and a signal of the trackpoint 7 is output to the CPU 20 via the touchpad 6 is also applicable.

The keyboard 5 outputs information corresponding to each key.

The touchpad 6 outputs the position of a finger on the operation surface as matrix coordinates, and outputs the contact pressure and the contact area on the operation surface.

The trackpoint 7 outputs the operation amount of the trackpoint 7, and outputs an active signal during a period in which an input operation is being performed.

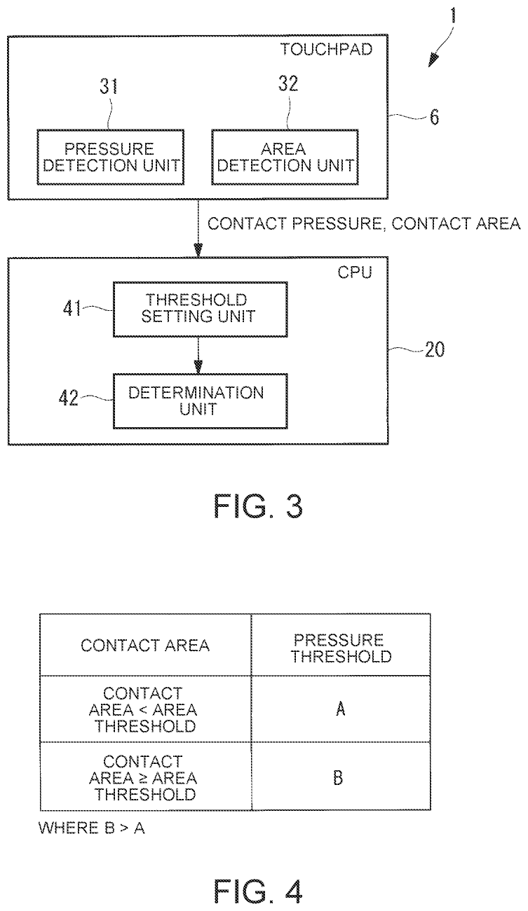

FIG. 3 is a functional block diagram schematically illustrating a functional structure relating to an input control function of the laptop PC 1 according to this embodiment.

As illustrated in FIG. 3, the laptop PC 1 according to this embodiment includes a pressure detection unit 31, an area detection unit 32, a threshold setting unit 41, and a determination unit 42. Although FIG. 3 illustrates the case where a controller of the touchpad 6 implements the functions of the pressure detection unit 31 and the area detection unit 32 and the CPU 20 implements the functions of the threshold setting unit 41 and the determination unit 42, a specific structure implementing each function is not limited. For example, the controller of the touchpad 6 may implement the functions of the threshold setting unit 41 and the determination unit 42, or the CPU 20 may implement all of these functions.

Processes for achieving various functions described below are stored in a computer-readable recording medium in the form of a program, and the touchpad controller, the CPU 20, or the like reads the program to the RAM and executes the program to achieve the various functions. The program may be, for example, preinstalled in the ROM or another storage medium, provided in a state of being stored in a computer-readable storage medium, or distributed through a wire or wireless communication means. Examples of the computer-readable storage medium include a magnetic disk, a magneto-optical disk, a CD-ROM, a DVD-ROM, and a semiconductor memory.

The pressure detection unit 31 detects the contact pressure on the operation surface of the touchpad 6. Specifically, the pressure detection unit 31 detects the contact pressure based on an output signal from the pressure sensor included in the touchpad 6. Herein, the “contact pressure” refers to the pressure when the user presses the touchpad 6 with an indicator such as a finger or a pen, that is, click down pressure.

For example, in the case where a plurality of pressure values is detected as a result of a plurality of locations being pressed simultaneously, the pressure detection unit 31 outputs a value obtained by statistically processing these values, e.g. an average value, a maximum value, or a minimum value, as a representative value. The contact pressure may be an instantaneous value, or a value obtained by temporally and spatially statistically processing pressure values output from the pressure sensor in a predetermined time.

The area detection unit 32 detects the contact area on the operation surface of the touchpad 6. Specifically, the area detection unit 32 detects the contact area based on an output signal from the pressure sensor included in the touchpad 6. For example, in the case where a plurality of locations is touched simultaneously or roughly simultaneously, the area detection unit 32 outputs a total value of these contact areas, as the contact area. The contact area may be an instantaneous value, or a value obtained by temporally and spatially statistically processing pressure values output from the pressure sensor in a predetermined time.

The threshold setting unit 41 sets a pressure threshold that differs depending on the contact area on the operation surface of the touchpad 6. Specifically, the threshold setting unit 41 has pressure threshold information associating contact areas detected by the area detection unit 32 with pressure thresholds, and sets the pressure threshold corresponding to the contact area using this information.

FIG. 4 is a diagram illustrating an example of the pressure threshold information. In the pressure threshold information illustrated in FIG. 4, the case where the contact area is less than a preset area threshold is associated with a first pressure threshold A, and the case where the contact area is greater than or equal to the area threshold is associated with a second pressure threshold B that is different from the first pressure threshold A. The second pressure threshold is higher than the first pressure threshold. The first pressure threshold is a pressure threshold (default value) normally used when determining a click operation.

The area threshold is set to, for example, about the area of a fingertip of a typical human hand. A click operation is normally performed by pressing the touchpad 6 with a fingertip. In the case where, for example, the side of the hand touches the touchpad 6 by mistake when the user is using the keyboard 5, the contact area on the touchpad 6 is larger than the area of the fingertip. Therefore, by setting the area threshold to about the area of a typical fingertip, whether the part touching the touchpad 6 is approximately equivalent to the fingertip of the user or the side of the palm of the user can be easily determined first. Given that the area of the fingertip varies among users, the area threshold may be customizable.

Although the pressure threshold is set in two stages in the pressure threshold information illustrated in FIG. 4, the present invention is not limited to this example, and the pressure threshold may be set in three or more stages. Instead of setting the pressure threshold in stages, the pressure threshold may be defined as a value that changes linearly or according to a predetermined function. The pressure threshold information may be defined as a look-up table as illustrated in FIG. 4, or the relationship between the contact area and the pressure threshold may be defined in other forms. For example, the pressure threshold information may be defined as a function formula of the pressure threshold with the contact area as a variable. In any of these cases, the relationship between the contact area and the pressure threshold is basically such that the pressure threshold is higher when the contact area is larger.

Thus, in the case where the contact area is greater than or equal to the area threshold and there is a possibility of an operation error, the pressure threshold is set to be higher than normal, to decrease the input sensitivity. This makes it possible to prevent an input error resulting from an operation error.

The determination unit 42 determines that the input operation is a predetermined input operation, in the case where the contact pressure on the operation surface of the touchpad 6, i.e. the contact pressure output from the pressure detection unit 31, is greater than or equal to the pressure threshold set by the threshold setting unit 41. In this case, an input signal corresponding to the input operation performed on the touchpad 6 is output to perform a process corresponding to the input signal. For example, the determination unit 42 determines that a click operation has been performed, and outputs a click signal which is an input signal relating to the click operation.

In the case where the contact pressure on the operation surface of the touchpad 6 is less than the pressure threshold, the determination unit 42 determines that the input operation performed on the touchpad 6 is not a click operation, and does not output an input signal (click signal) corresponding to the input operation.

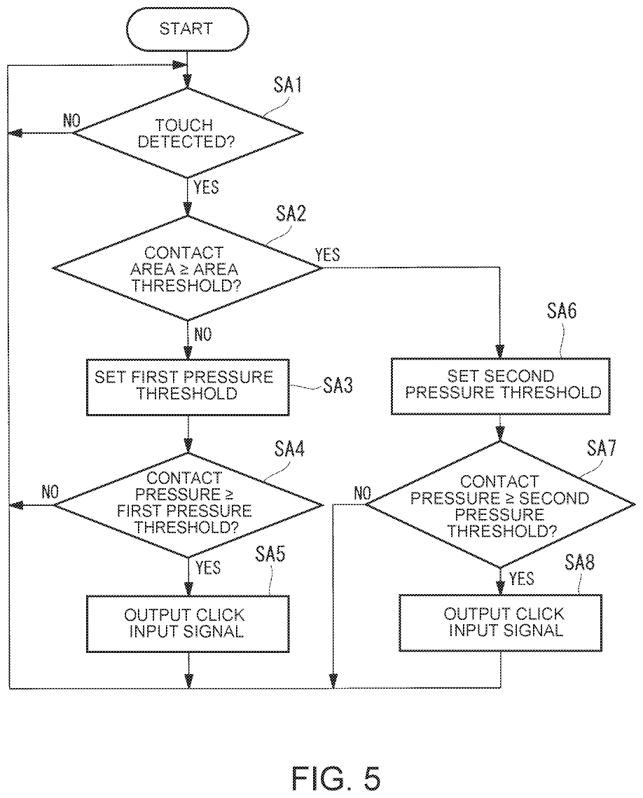

An input control method performed by the laptop PC 1 will be described below, with reference to FIG. 5. FIG. 5 is a flowchart illustrating an example of a procedure of the input control method according to this embodiment. For example, the start of this process is triggered by the start of the laptop PC 1.

First, whether a touch on the operation surface of the touchpad 6 is detected is determined (SA1). In the case where a touch is not detected (SA1: NO), step SA1 is repeated until a touch is detected. In the case where a touch is detected (SA1: YES), whether the contact area is greater than or equal to the preset area threshold is determined (SA2). In the case where the contact area is less than the area threshold (SA2: NO), that is, in the case where the contact area is approximately the contact area of a fingertip, the first pressure threshold A (default value) is set (SA3), and whether the contact pressure is greater than or equal to the first pressure threshold A is determined (SA4). In the case where the contact pressure is greater than or equal to the first pressure threshold A (SA4: YES), e.g. in the case where the touchpad 6 is pressed with a pressure greater than or equal to the first pressure threshold A as a result of the user performing a click operation intentionally, it is determined that the input operation is a click operation, and a click signal is output (SA5). The process then returns to step SA1. In the case where it is determined in step SA4 that the contact pressure is less than the first pressure threshold A, it is determined that the input operation is an input operation due to cursor movement or the like and is not a click operation, and the process returns to step SA1 without outputting a click signal.

In the case where the contact area is greater than or equal to the area threshold in step SA2 (SA2: YES), the second pressure threshold B higher than the first pressure threshold A (default value) is set (SA6). Following this, whether the contact pressure is greater than or equal to the second pressure threshold B is determined (SA7). In the case where the contact pressure is less than the second pressure threshold B (SA7: NO), it is determined that the input operation is an operation error, and the process returns to step SA1 without outputting an input signal (click signal) corresponding to the input operation. In the case where the contact pressure is greater than or equal to the second pressure threshold B in step SA7 (SA7: YES), it is determined that the input operation is a click operation intentionally performed by the user using the palm or the like, and a click signal is output (SA8). The process then returns to step SA1.

As described above, with the information processing apparatus and the input control method according to this embodiment, whether the input operation by the user is an input error is determined using the pressure threshold corresponding to the contact area on the touchpad 6. Specifically, the pressure threshold is set to be higher in the case where the contact area on the operation surface of the touchpad 6 is greater than or equal to the predetermined area threshold than in the case where the contact area is less than the area threshold.

In the case where the contact area is greater than or equal to the predetermined contact area, it can be estimated that a part other than a fingertip is touching the touchpad 6. In the case where it can be estimated that a part other than a fingertip is touching the touchpad 6, a pressure threshold higher than in the case where the contact area is less than the predetermined contact area is set to decrease the input sensitivity. This makes it possible to prevent an input error caused by an erroneous input operation not intended by the user, such as a part of the hand unintentionally touching the touchpad 6 when the user is using the keyboard.

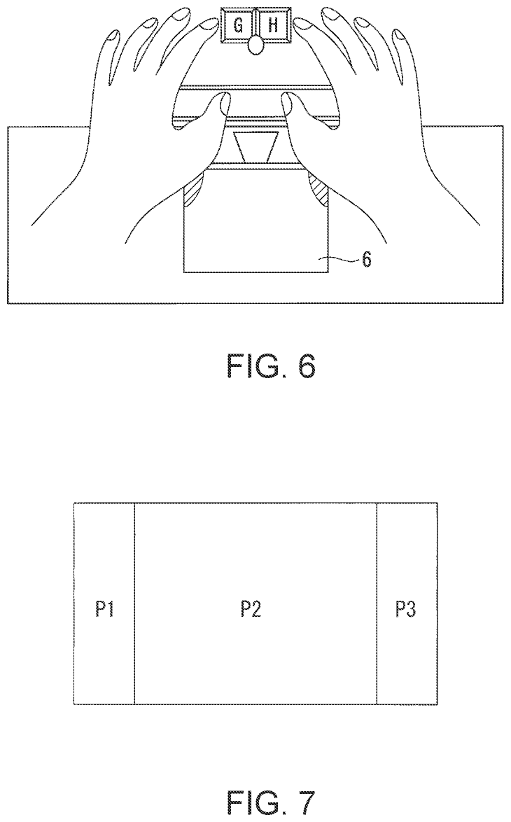

Although the pressure threshold is uniform throughout the operation surface of the touchpad 6 in this embodiment, for example, the operation surface may be virtually divided into a plurality of regions, and a pressure threshold may be set for each of the regions. For example, the base of the thumb may unintentionally touch the touchpad 6 when the user is performing key input with the hands being placed at the home position of the keyboard 5, as illustrated in FIG. 6. In such a case, the load of each hand is exerted more on the chassis part near the touchpad 6 than on the touchpad 6, so that the load on the touchpad 6 is likely to be less than in the case where an operation error occurs in the central part.

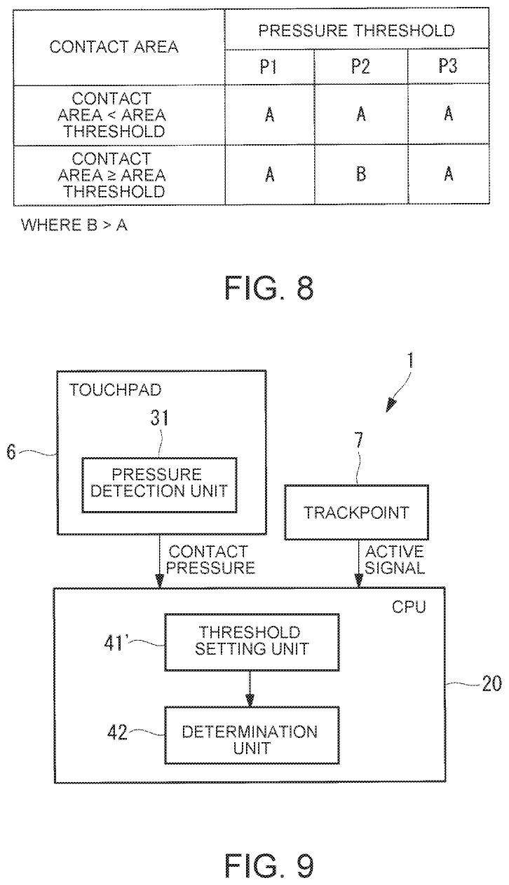

In view of this, the following structure may be used: The operation surface of the touchpad 6 is divided into a central part P2 and both end parts P1 and P3 as illustrated in FIG. 7, and the pressure threshold information is set so that the pressure threshold in the central part P2 is higher than the pressure threshold in the end parts P1 and P3 as illustrated in FIG. 8. By virtually dividing the operation surface of the touchpad 6 into a plurality of regions and setting a pressure threshold for each region depending on the load on the touchpad 6 during typing in this way, an input error by the user is expected to be further prevented.

There are cases where the touchpad 6 has a haptic function of producing vibration in response to an input operation and notifying the user of a click operation through a tactile sense, in order to improve operability and user satisfaction. In the case where the touchpad 6 has such a haptic function, a pressure threshold when producing vibration is set for each of click down and click up. If the pressure threshold for click down determined as a click operation is changed as described above, it is preferable to also change the pressure threshold for click up along with the change of the pressure threshold for click down. By changing the pressure threshold for determining click up along with the pressure threshold for determining click down, natural vibration can be produced even in the case where the user performs a click operation with a large contact area such as the side of the palm.

### Second Embodiment

An information processing apparatus and an input control method according to a second embodiment of the present invention will be described below, with reference to drawings.

In the first embodiment described above, the pressure threshold differs depending on the contact area on the operation surface of the touchpad 6. This embodiment is different from the first embodiment in that the pressure threshold differs depending on whether the trackpoint 7 is in use.

The differences from the first embodiment will be mainly described below, while omitting description for the same structures and functions as those in the first embodiment.

FIG. 9 is a functional block diagram schematically illustrating a functional structure relating to an input control function of a laptop PC according to the second embodiment of the present invention.

As illustrated in FIG. 9, the laptop PC according to this embodiment includes a pressure detection unit 31, a threshold setting unit 41′, and a determination unit 42. Although FIG. 9 illustrates the case where the controller of the touchpad 6 implements the function of the pressure detection unit 31 and the CPU 20 implements the functions of the threshold setting unit 41′ and the determination unit 42, a specific processing section implementing each function is not limited, as in the first embodiment.

The pressure detection unit 31 detects the contact pressure on the operation surface of the touchpad 6.

The trackpoint 7 outputs an active signal in the case where the trackpoint 7 is being operated.

The threshold setting unit 41′ sets a pressure threshold that differs depending on whether the trackpoint 7 is in use. Specifically, the threshold setting unit 41′ has pressure threshold information in which a different pressure threshold is registered depending on whether the active signal indicating that the trackpoint 7 is in use is input, and sets the pressure threshold using this information.

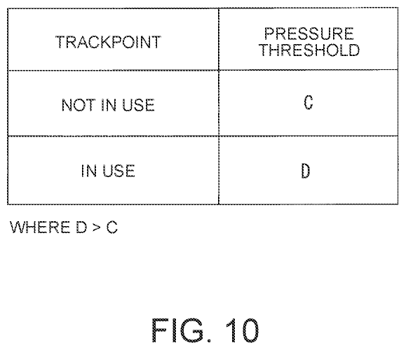

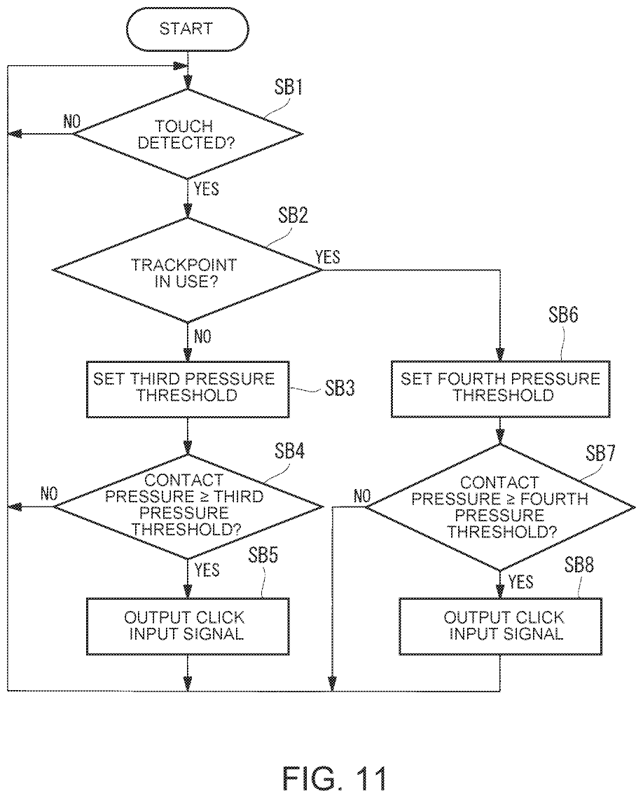

FIG. 10 is a diagram illustrating an example of the pressure threshold information. In the pressure threshold information illustrated in FIG. 10, the case where the trackpoint 7 is not in use, i.e. the case where the active signal is not input, is associated with a third pressure threshold C, and the case where the trackpoint 7 is in use, i.e. the case where the active signal is input, is associated with a fourth pressure threshold D that is different from the third pressure threshold C. The fourth pressure threshold D is higher than the third pressure threshold C. The third pressure threshold C is, for example, a pressure threshold (default value) normally used when determining a click operation. The third pressure threshold C may be the same value as or a different value from the foregoing first pressure threshold A. The fourth pressure threshold D may be the same value as or a different value from the foregoing second pressure threshold B.

The determination unit 42 is the same as that in the foregoing first embodiment, and outputs an input signal (e.g. click signal) corresponding to the input operation performed on the touchpad 6 in the case where the contact pressure on the operation surface of the touchpad 6, i.e. the contact pressure output from the pressure detection unit 31, is greater than or equal to the pressure threshold set by the threshold setting unit 41′. In the case where the contact pressure on the operation surface of the touchpad 6 is less than the pressure threshold, the determination unit 42 determines that the input operation is an operation error, and does not output the input signal corresponding to the input operation.

An input control method performed by the laptop PC will be described below, with reference to FIG. 11. For example, the start of this process is triggered by the start of the laptop PC.

First, whether a touch on the operation surface of the touchpad 6 is detected is determined (SB1). In the case where a touch is not detected (SB1: NO), step SB1 is repeated until a touch is detected. In the case where a touch is detected (SB1: YES), whether the trackpoint is in use is determined (SB2). In the case where the trackpoint is not in use (SB2: NO), the third pressure threshold C (e.g. default value) is set (SB3), and whether the contact pressure is greater than or equal to the third pressure threshold C is determined (SB4). In the case where the contact pressure is greater than or equal to the third pressure threshold C (SB4: YES), e.g. in the case where the touchpad 6 is pressed with a pressure greater than or equal to the third pressure threshold C as a result of the user performing a click operation intentionally, it is determined that the input operation is a click operation, and a click signal is output (SB5). The process then returns to step SB1.

In the case where it is determined in step SB4 that the contact pressure is less than the third pressure threshold C, it is determined that the input operation is an input operation due to cursor movement or the like and is not a click operation, and the process returns to step SB1 without outputting a click signal.

In the case where the trackpoint is in use in step SB2 (SB2: YES), the fourth pressure threshold D higher than the third pressure threshold C (e.g. default value) is set to decrease the input sensitivity (SB6). Following this, whether the contact pressure is greater than or equal to the fourth pressure threshold D is determined (SB7). In the case where the contact pressure is less than the fourth pressure threshold D (SB7: NO), it is determined that the input operation is an operation error, and the process returns to step SB1 without outputting an input signal (click signal) corresponding to the input operation. In the case where the contact pressure is greater than or equal to the fourth pressure threshold D in step SB7 (SB7: YES), it is determined that the input operation is a click operation, and a click signal is output (SB8). The process then returns to step SB1.

As described above, with the information processing apparatus and the input control method according to this embodiment, a different pressure threshold is set depending on whether the trackpoint is in use, so that the input sensitivity can be changed depending on whether the trackpoint is in use. Specifically, the probability of an operation error tends to be higher in the case where the trackpoint is in use than in the case where the trackpoint is not in use. Accordingly, in the case where the trackpoint is in use, the pressure threshold of the contact pressure is set to be higher than in the case where the trackpoint is not in use, to decrease the input sensitivity. This makes it possible to prevent an input error caused by use of the trackpoint.

In the second embodiment, the operation surface of the touchpad 6 may be virtually divided into a plurality of regions and the pressure threshold may be set for each of the regions, as in the first embodiment. In this case, at least one of the regions may be selected and a higher pressure threshold may be set in the selected region than in the other regions.

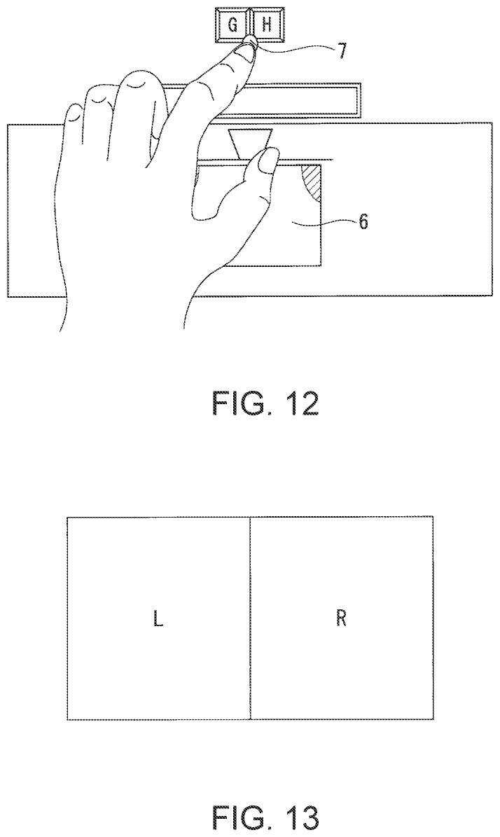

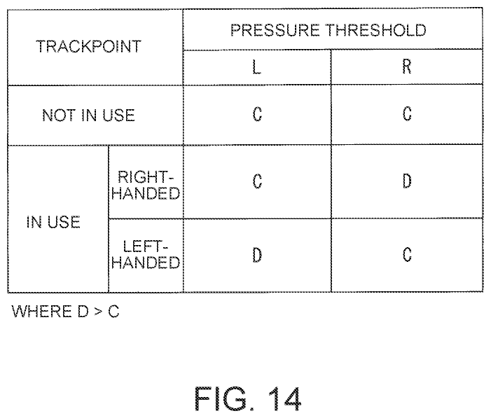

In the case where the trackpoint 7 is in use, for example, a region in which the user unintentionally touches the touchpad 6 differs depending on the dominant hand of the user, as illustrated in FIG. 12. For example, in the case where the user is left-handed, the user tends to use the trackpoint 7 with the left hand as illustrated in FIG. 12, so that the probability of an input error is higher in the left region from the center on the operation surface of the touchpad 6. It is therefore preferable to set, in the case where the user is left-handed, the pressure threshold in the left region to be higher than the pressure threshold in the right region. Likewise, it is preferable to set, in the case where the user is right-handed, the pressure threshold in the right region to be higher than the pressure threshold in the left region. By setting the pressure threshold in the region corresponding to the dominant hand of the user to be higher than the pressure threshold in the region not corresponding to the dominant hand in the case where the trackpoint 7 is in use in this way, an input error by the user is expected to be further prevented. FIG. 13 illustrates an example of virtual division of the operation surface of the touchpad 6 in such a case. FIG. 14 illustrates an example of pressure threshold information in the case where the operation surface is divided as illustrated in FIG. 13.

As a dominant hand determination method, for example, dominant hand information set by the user may be stored in a storage unit and used to determine the dominant hand.

Alternatively, the dominant hand may be determined based on the operation history of the trackpoint 7. As an example, the dominant hand may be determined based on the tendency of a strain value detected by a strain sensor included in the trackpoint 7. For example, the feature of the strain value acquired by the strain sensor differs between a right-handed person, i.e. a person who mainly operates the trackpoint 7 with the right hand, and a left-handed person, i.e. a person who mainly operates the trackpoint 7 with the left hand. Hence, the dominant hand may be determined depending on whether the history information of the strain value acquired by the strain sensor indicates history of strain value specific to a right-handed person or history of strain value specific to a left-handed person.

Moreover, the dominant hand may be determined based on the contact distribution of the touchpad 6 during the time when the user is operating the trackpoint 7. For example, while the user is operating the trackpoint 7, a distribution of contact corresponding to an area greater than or equal to a predetermined threshold on the touchpad 6 is acquired, and the side on which such contact has occurred a larger number of times is determined as the dominant hand. After determining the dominant hand in this way, the pressure threshold in the region corresponding to the dominant hand is set to be higher than the pressure threshold in the region not corresponding to the dominant hand as described above.

The present invention is not limited to these dominant hand determination methods, and other methods may be used.

While the present invention has been described by way of the foregoing embodiments, the technical scope of the present invention is not limited to the foregoing embodiments. Various changes or modifications can be made to the foregoing embodiments without departing from the scope of the present invention, and such changes or modifications are also included in the technical scope of the present invention. The foregoing embodiments may also be combined as appropriate.

The processing flows illustrated in FIGS. 5 and 11 in the foregoing embodiments are examples, and omission of unnecessary steps, addition of new steps, and change of processing order may be made without departing from the scope of the present invention.

Although the foregoing embodiments describe the case where the information processing apparatus is a laptop PC, the present invention is not limited to such, and the information processing apparatus may be a desktop PC, a tablet PC, a personal digital assistant (PDA), or the like.

### DESCRIPTION OF SYMBOLS

1 laptop PC
2 main body-side chassis
3 display-side chassis
4 input device
5 keyboard
6 touchpad
7 trackpoint
8 display
9a connecting portion
9b connecting portion
20 CPU
21 ROM
22 memory
23 flash memory
24 graphics adapter
25 communication device
26 power circuit
27 embedded controller
28 bus
31 pressure detection unit
32 area detection unit
41, 41′ threshold setting unit
42 determination unit

What is claimed is:

1. An information processing apparatus comprising:
a pressure detection unit that detects a contact pressure on an operation surface of a touchpad;
an area detection unit that detects a contact area on the operation surface of the touchpad;
a threshold setting unit that sets a pressure threshold that differs depending on the contact area on the operation surface of the touchpad; and
a determination unit that determines an input operation as a predetermined input operation, in a case where the contact pressure on the operation surface of the touchpad is greater than or equal to the pressure threshold.

2. The information processing apparatus according to claim 1, wherein the threshold setting unit sets the pressure threshold to be higher in a case where the contact area on the operation surface is greater than or equal to a predetermined area threshold than in a case where the contact area is less than the area threshold.

3. The information processing apparatus according to claim 1, wherein the threshold setting unit virtually divides the operation surface of the touchpad into a plurality of regions, and sets the pressure threshold for each of the plurality of regions.

4. The information processing apparatus according to claim 3, wherein the threshold setting unit sets the pressure threshold in a central part of the operation surface to be higher than the pressure threshold in an end part of the operation surface.

5. An information processing apparatus comprising:
a touchpad;
a trackpoint;
a threshold setting unit that sets a pressure threshold that differs depending on whether the trackpoint is in use; and
a determination unit that determines an input operation as a predetermined input operation, in a case where a contact pressure on an operation surface of the touchpad is greater than or equal to the pressure threshold.

6. The information processing apparatus according to claim 5, wherein the threshold setting unit sets the pressure threshold to be higher in a case where the trackpoint is in use than in a case where the trackpoint is not in use.

7. The information processing apparatus according to claim 5, wherein the threshold setting unit virtually divides the operation surface of the touchpad into a plurality of regions, and sets the pressure threshold for each of the plurality of regions.

8. The information processing apparatus according to claim 7, wherein the threshold setting unit selects at least one region of the plurality of regions, and sets the pressure threshold in the selected at least one region to be higher than the pressure threshold in other regions.

9. The information processing apparatus according to claim 8, wherein the threshold setting unit selects the at least one region based on a setting of a user.

10. The information processing apparatus according to claim 8, wherein the threshold setting unit selects the at least one region based on an operation history of the trackpoint.

11. The information processing apparatus according to any of claim 1, wherein the predetermined input operation is a click operation.

12. An input control method for an information processing apparatus including a touchpad, the input control method comprising:
detecting a contact pressure on an operation surface of the touchpad;
detecting a contact area on the operation surface of the touchpad;
setting a pressure threshold that differs depending on the contact area on the operation surface of the touchpad; and
determining an input operation as a predetermined input operation, in a case where the contact pressure on the operation surface of the touchpad is greater than or equal to the pressure threshold.

13. An input control method for an information processing apparatus including a touchpad and a trackpoint, the input control method comprising:
setting a pressure threshold that differs depending on whether the trackpoint is in use; and
determining an input operation as a predetermined input operation, in a case where a contact pressure on an operation surface of the touchpad is greater than or equal to the pressure threshold.
